(19) United States
(12) Patent Application Publication
(10) Pub. No.: US 2006/0258380 A1
(43) Pub. Date: Nov. 16, 2006

(54) Interactive opt-in-messaging

(76) Inventors: Kai Liebowitz, Thousand Oaks, CA (US); Tyler Liebowitz, Los Angeles, CA (US); David Sklaver, Chappaqua, NY (US)

Correspondence Address: SoCAL IP LAW GROUP LLP, 310 N. WESTLAKE BLVD. STE 120, WESTLAKE VILLAGE, CA, 91362, US

(21) Appl. No.: 11/298,109

(22) Filed: Dec. 8, 2005

Related U.S. Application Data
(63) Continuation-in-part of application No. 11/150,050, filed on Jun. 10, 2005.
(60) Provisional application No. 60/681,676, filed on May 16, 2005.

(51) Int. Cl. H04Q 7/20

(52) U.S. Cl. 455/466

(57) ABSTRACT

There are disclosed processes and systems for interactive opt-in messaging. A mobile phone user may enroll in a content delivery service at the invitation of a broadcast program. A content program may then be delivered to the mobile phone. The content program may include a series of messages having interest content and solicitation content. The solicitation content may include a solicitor phone number. A user of the mobile phone may respond to the solicitation content from the mobile phone without having to re-key the solicitor phone number.

### RELATED APPLICATION INFORMATION

This patent application claims priority from Provisional Application No. 60/681,676 filed May 16, 2005, and patent application Ser. No. 11/150,050 filed Jun. 10, 2005, both of which are incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The present invention relates to interactive opt-in messaging.

2. Description of the Related Art

Mobile phone (e.g., cellular) standards include a short message service (SMS) function, allowing text messages to be sent to and from mobile terminals.

In a marketing campaign run by the Pepsi-Cola Company in Sweden, a question and a telephone number were printed on bottle tops. Customers were encouraged to send their answer to the question as an SMS message from their mobile telephone. If the answer was correct, a second question would be sent to that mobile telephone via SMS. At the end of the competition, various prizes were awarded to customers who answered all questions correctly.

Television programs have provided their viewing audiences the ability to interact with the program. Audience members have been able to vote for contestants on television programs by placing telephone calls to specially reserved numbers. Typically, a separate phone number is associated with each contestant, and the vote is tallied when the audience member's phone call is connected. The television program displays the phone numbers for voting for the contestants. This same paradigm has been adopted to SMS, wherein audience members send SMS messages instead of placing phone calls.

In another SMS-based form of interactivity, television programs have allowed their audience members enroll in services to obtain information about the television program. For example, some television programs will prompt enrolled audience members when voting windows open.

SMS-based quizzes have also been produced. Typically, a user sends an SMS message to a particular address to enroll. Periodically, the producers send a question to the enrolled users via SMS, and the users respond via SMS with their answers.

### DESCRIPTION OF THE DRAWINGS

FIG. 1 is a diagram of a system for sending and receiving interactive opt-in messages.

FIG. 2 is a flow chart of a method of interactive opt-in messaging for receiving content on a communications device.

FIG. 3 is a flow chart of a method of sending interactive opt-in messages.

FIG. 4 is a screen display of enrollment by a user on a mobile device.

FIG. 5 is a screen display of a received message on a mobile device confirming enrollment.

FIG. 6 is a screen display of an automated call to a solicitor phone number.

FIG. 7 is a screen display of a quiz question received on a mobile device.

FIG. 8 is a screen display of a contest update received on a mobile device.

### DETAILED DESCRIPTION OF THE INVENTION

Throughout this description, the embodiments and examples shown should be considered as exemplars, rather than limitations on the apparatus and methods of the present invention.

As will be seen, according to aspects of the invention, the broad power of television is combined with the intimacy of mobile phones to create a powerful direct response vehicle that circumvents unwanted incoming solicitations.

Description of Systems

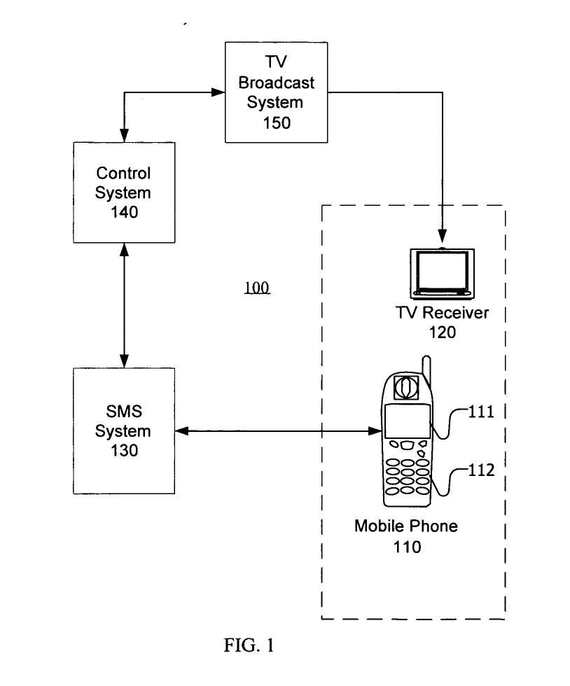

Referring now to FIG. 1 there is shown a diagram of a system 100 for sending and receiving interactive opt-in messages. The system 100 includes a mobile phone 110, a TV receiver 120, an SMS system 130, a control system 140 and a TV broadcast system 150. Additional and fewer units, modules or other arrangements of software, hardware and data structures may be used to achieve the functionality described herein.

The mobile phone 110 may be a cellular phone, PDA, wireless VoIP phone, desktop computer, laptop computer, hand held computing device or other device which can initiate voice communications sessions and send and receive text and/or other messages. The mobile phone 10 includes a display 111 and a keypad 112.

The TV receiver 120 may be a display device having a tuner or other decoder for receiving broadcast, multicast, narrowcast and other video signals and data, and displaying video from those signals and data. The TV receiver 120 may be able to receive and process analog or digital signals, and may receive signals wirelessly and/or through wires, fiber, etc. The TV receiver 120 may be a single device, or may be a number of connected devices.

The SMS system 130 is a device or system communicative with a telephone and/or data network for generating text messages and/or messages in other forms to devices such as the mobile phone 110, and for receiving and processing such messages.

The TV broadcast system 150 transmits video programs that may be received on the TV receiver 120. The TV broadcast system 150 may be, for example, a television broadcast system, or a video on demand system. The TV broadcast system 150 may transmit wirelessly, wireline, and may be digital and/or analog. The TV broadcast system may operate over or with Internet, and may be an IP TV system or a system which integrates broadcast TV with data, or an interactive system. The TV broadcast system 150 may receive video programs from external sources and/or may originate them.

The control system 140 is a system which can control the generation and receipt of content programs and may cooperate with the SMS system 130 in this regard. The control system 140 may also be connected to the TV broadcast system 150, and may coordinate transmission of video programs by the TV broadcast system 150 with text messaging and other content programs through the SMS system 130.

The system 100 may include software and/or hardware for providing functionality and features described herein, both within the mobile phone 110, the TV receiver 120, the SMS system 130, the control system 140 and the TV broadcast system 150, and otherwise. Various components of the system 100 may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). (PLAs). The hardware and firmware components of the system 100 may include various specialized units, circuits, software and interfaces for providing the functionality and features described here. The invention may be embodied in whole or in part in software which operates on the mobile phone 110, the TV receiver 120, the SMS system 130, the control system 140 and/or the TV broadcast system 150 and may be in the form of firmware, an application program, an applet (e.g., a Java applet), a browser plug-in, a COM object, a dynamic linked library (DLL), a script, one or more subroutines, or an operating system component or service. The hardware and software of the invention and its functions may be distributed such that some components are performed by one device or system and others by other devices or systems. The SMS system 130, the control system 140 and/or the TV broadcast system 150 may each be formed from a collection of physically unified or distributed components. Likewise, the mobile phone 110 and the TV receiver may have distributed components, though in most embodiments the components will be either physically unitary or in close proximity.

The techniques described herein may be implemented with any storage media in any storage device included with or otherwise coupled or attached to a computing device. As used herein, a storage device is a device that allows for reading and/or writing to a storage medium. Storage devices include, hard disk drives, DVD drives, flash memory devices, tape, CD drives.

By data unit, it is meant a frame, cell, datagram, packet or other unit of information.

Description of Methods

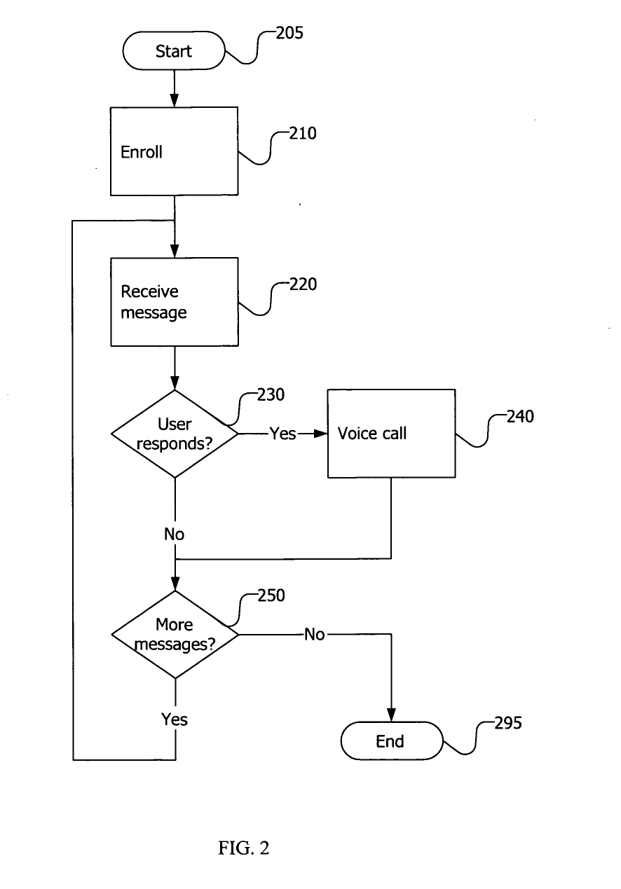

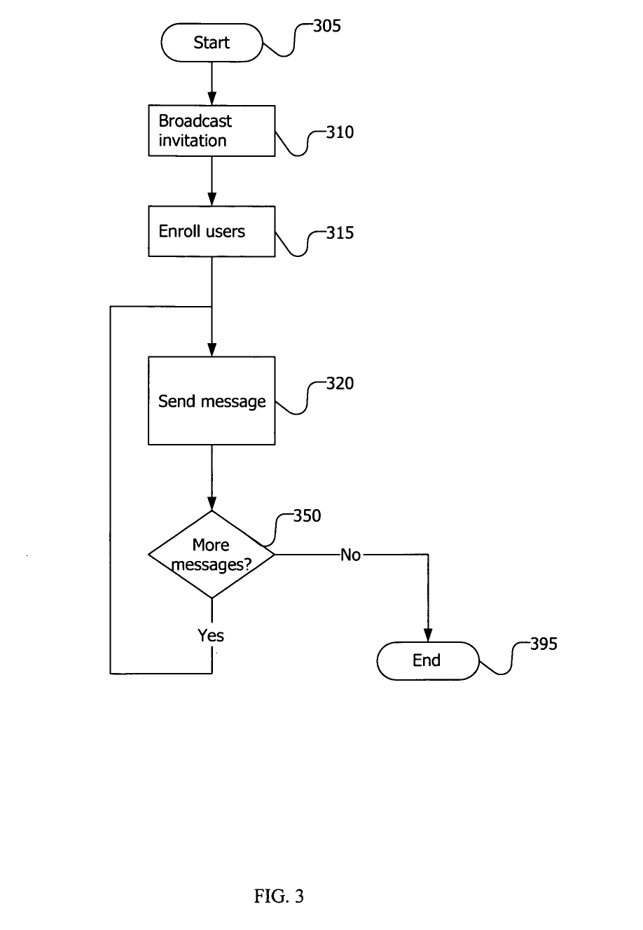

Referring now to FIG. 2 there is shown a flow chart of a method of interactive opt-in messaging for receiving content on a communications device such as the mobile phone 110. The discussion of FIG. 2 comes from the perspective of the end user; the discussion of FIG. 3 comes from the perspective of the service provider. FIG. 2 has both a start 205 and an end 295, but the process is cyclical in nature.

Consider a situation where a person (or “user”) is watching a television program on the TV receiver 120 which is generated by the TV broadcasting system 150. The television program may include an invitation to the viewing audience to enroll in (i.e., opt-in to) a content delivery service. The content delivery service is for transmitting one or content programs, as explained herein. The television program may explain or suggest that the content program will be transmitted as a series of messages to a designated device, such as text, graphic, video, audio, multimedia or messages to a person's mobile phone. The invitation may be advantageously presented in a TV10™, which is a 10 second commercial spot potentially appearing at many different potential points in a television program.

The invitation to enroll may come from various sources, such as print media, radio, video, web, email, or a live stadium/theater/auditorium event, etc. The invitation may be included in the program or may be physically or logically separate. For example, in television, the invitation could be included in a television program or in a commercial separate from the television program. Furthermore, the invitation can be distributed, for example with part of the invitation in a television program and part in a commercial. Further still, the invitation can be made in combinations of media. To improve the impact of the invitation, it may be desirable to integrate the tone, them and content of the invitation with the program. Alternatively, the impact may be improved by making the invitation noticeably different from the program. For convenience, the following description is made with respect to a television broadcast of the invitation.

The content program may be interactive or passive. An interactive content program may be, for example, an interactive quiz, a contest, a poll or a survey. A passive content program may be a story or an educational lesson. The content program may originate entirely from a single source or from multiple sources. The content program may be distributed, having a peer-to-peer arrangement, having a multi-player arrangement, or inter-player messaging capabilities. Winning players may receive compensation and/or awards.

The invitation may convince the person that the content program will be in an area of interest to the person. Some people may be interested in audience-participation opportunities, others with competition regarding knowledge of particular kinds of information, still others with insider information that is not generally available. Thus, the person enrolls in a content delivery service for receiving the content program (step 210). The person may enroll to receive content programs in one or more areas of interest. For simplicity, the following discussion is made with respect to a single content program.

The person may use the same communications device for enrollment and for receipt of the content program, or the person may designate another communications device for receipt of the content program. The designated communications device may be owned or controlled by the enrollee, or may be owned or controlled by another.

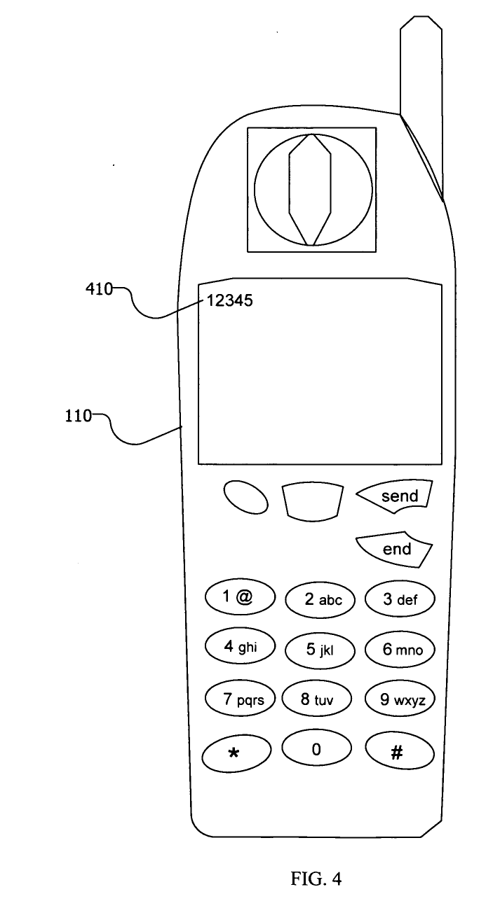

The person may enroll by sending an opt-in message to an address designated in the invitation. The opt-in message may be a simple text message, such as “enroll” or “subscribe”, a short (e.g., five letters/numbers) code or “speed code” (such as that shown in FIG. 4), a phone number of the communications device, or even no text. The person may send an opt-in message by sending an SMS or other type of message or making a voice call to a designated electronic address. The designated address may be a full telephone number or a speed code associated, e.g., with the SMS system 130, a reply text address, an email address and/or website address. The person may be able to enroll from a web site.

Enrollment may also be enabled using an interactive voice response (IVR) system. With IVR, a person can make a voice call to a designated telephone number (e.g., a toll free number) that will prompt the person to answer a question by speaking the answer and/or by pressing an appropriate key on the phone's keypad. Using caller ID, ANI or other services, the IVR system can capture the person's phone number and other useful information. The IVR system may be integrated, for example, into the SMS system 130 or the control system 140, or may be separate.

The person may then receive the content program as a series of messages in the designated communications device (step 220). The messages may include content which is user perceivable and not user-perceivable. The messages may have user-perceivable content which is related in that the individual messages form a content program having common thematic or subject matter. By user-perceivable it is meant that the user can experience the content from the communications device in the form intended by the sender. This contrasts with hacks in which hidden content such as control information is accessed by a user.

The messages may have two kinds of content. One kind of content in the messages corresponds to the subject of the content program—i.e., the area of interest. The second kind of content is a solicitation.

The solicitation content may include a prompt to which the user can respond directly from the communications device. The solicitation content may be produced or controlled by a sponsor of the content program and/or the television program. The solicitation content may relate to a single solicitor or multiple solicitor.

The make-up of the messages of the content program may vary, such that some messages include only interest content, and others some combination. Alternatively, all messages may include both interest content and solicitation content.

It may be desirable to have some sensitivity about the scope of enrollment of the users. In this regard, although messages could be sent with solicitation content but not interest content, this might violate the spirit or agreement of the opt-in process. Thus, in most implementations, messages probably will not be sent without interest content, or only with solicitation content.

The first message from the content delivery service may be an acknowledgement of the enrollment. Furthermore, the user can be asked to confirm the acknowledgment using SMS or other means. This results in a double opt-in process, since the user first asks to be enrolled, and then confirms enrollment. Further, the user may be asked to confirm agreement to charges for receiving and/or participating in the content program. Depending on the process, this might be considered a triple opt-in.

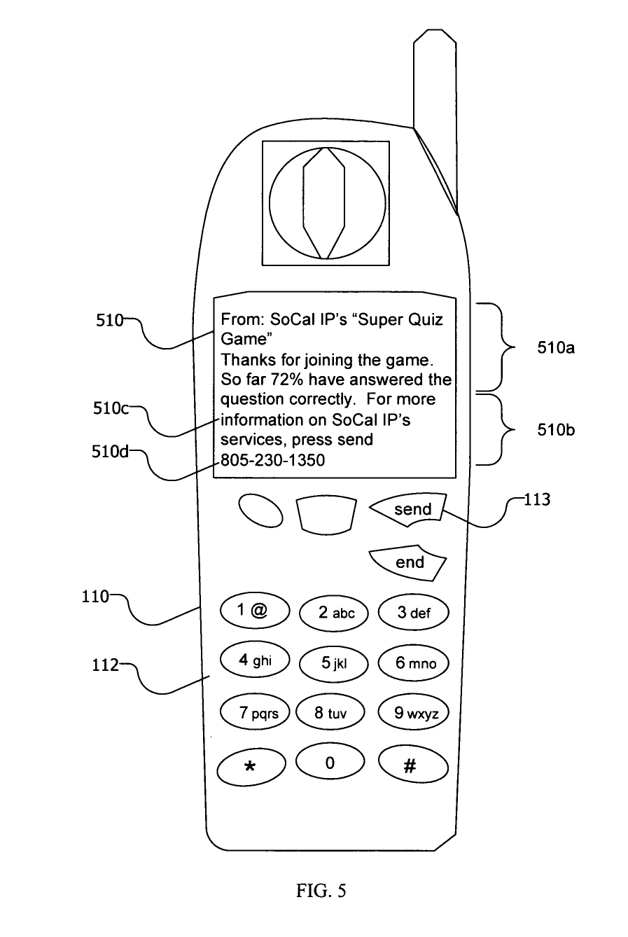

Referring now to FIG. 5 there is shown a screen display of a received message 510 510 on the mobile phone 110. The received message includes interest content 510a and solicitation content 510b. In this example, the interest content 510a confirms enrollment in a game. The solicitation content 510b includes a solicitation 510c and a solicitor phone number 510d. Instead of a solicitor phone number, the solicitor-content may include some other form of electronic address for contacting the solicitor with respect to the solicitation, such as an IP address for a VoIP call. The solicitor phone number of electronic address may be user-perceivable or not, though making it user-perceivable may create greater trust with the user and also allow the user to contact the solicitor less directly.

In FIG. 5, the solicitation content 510b is distinct from the interest content 510a. However, the interest content and solicitation content may be intermingled—in time, space and/or form.

The solicitations may take various forms, such as, “Would you like to know more about . . . ”, “Would you like free samples . . . ”, “Would you like coupons . . . ”, “Would you like to speak with a live operator . . . ”, or “Would you like to log on to their Web site or send an e-mail . . . ”

The user of the mobile phone 100 may respond to one of the solicitations from the mobile phone 110 (FIG. 2, step 230). This may be accomplished by pressing a button, such as a send button 113 on the keypad 112. Pressing the send button 113 results in a call (e.g., a voice call) being initiated to the solicitor's phone number (FIG. 2, step 240). The call may be initiated in other ways, such as by pressing other buttons or combinations of buttons, through a voice command, through a soft buttons, or otherwise.

The mobile phone 110 or the network to which it connects may be able to process the message 510 to extract the solicitor phone number 510d. In this regard, the mobile phone may extract the solicitor phone number 510d in response to the user pressing the send button 113. Likewise, the requisite intelligence may reside in whole or in part in the mobile carrier's network, and the solicitor phone number 510d may be extracted in conjunction with delivery of the message, or extracted in response to the user pressing the send button 113.

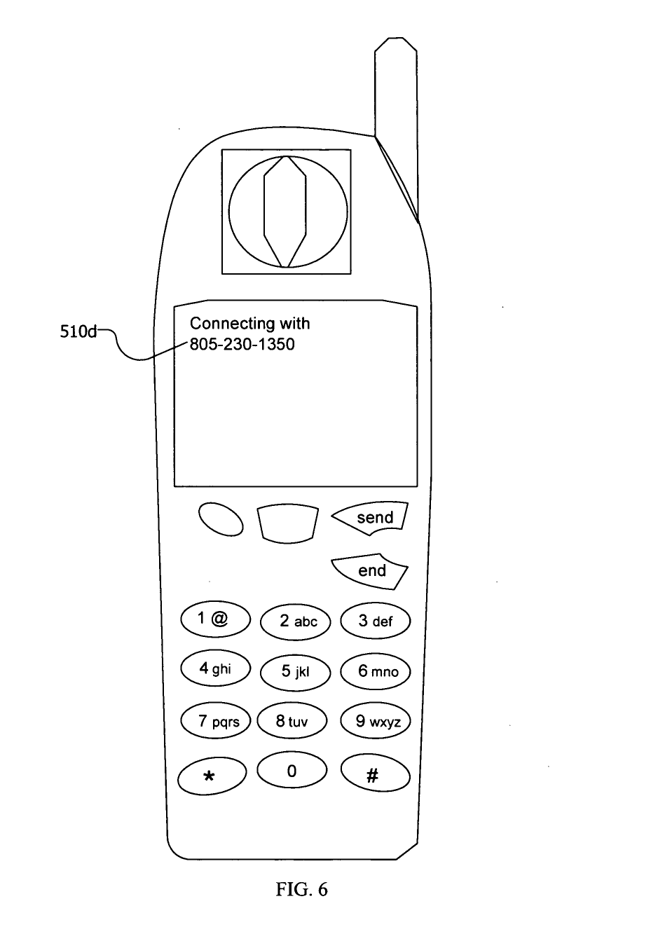

Referring now to FIG. 6 there is shown a screen display of an automated call to the solicitor phone number 510d. Thus, the user can initiate a phone call to the solicitor phone number directly from the solicitation and without the user separately keying in the solicitor phone number.

Although different facilities for users to respond to solicitations may be provided, it is believed that simplified initiation of a voice call to the solicitor is particularly beneficial. Further benefits may be obtained by connecting the user to a live operator with whom the user can discuss the solicitation and clarify the request. This eliminates the greatest stumbling block to mobile direct marketing . . . the unsolicited call or text.

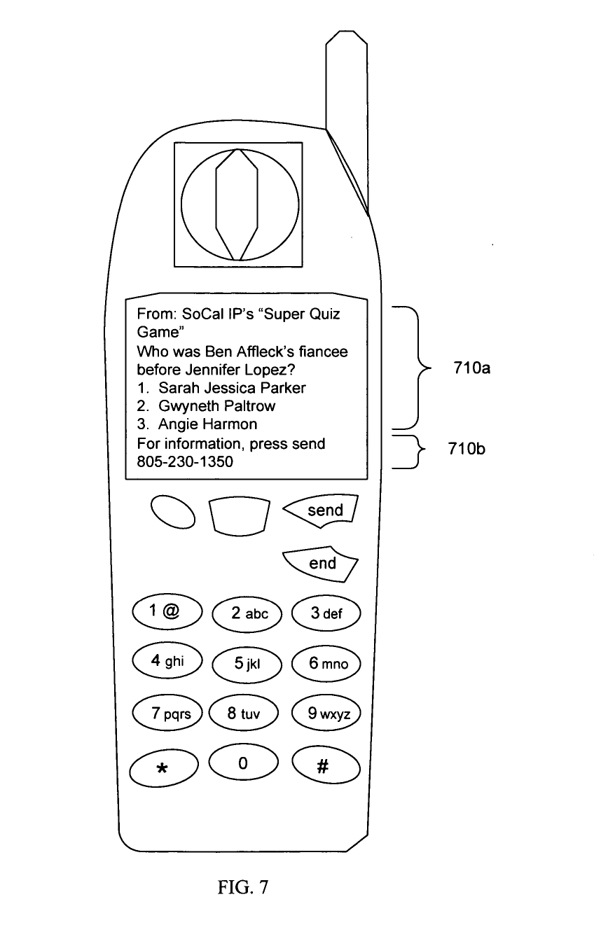

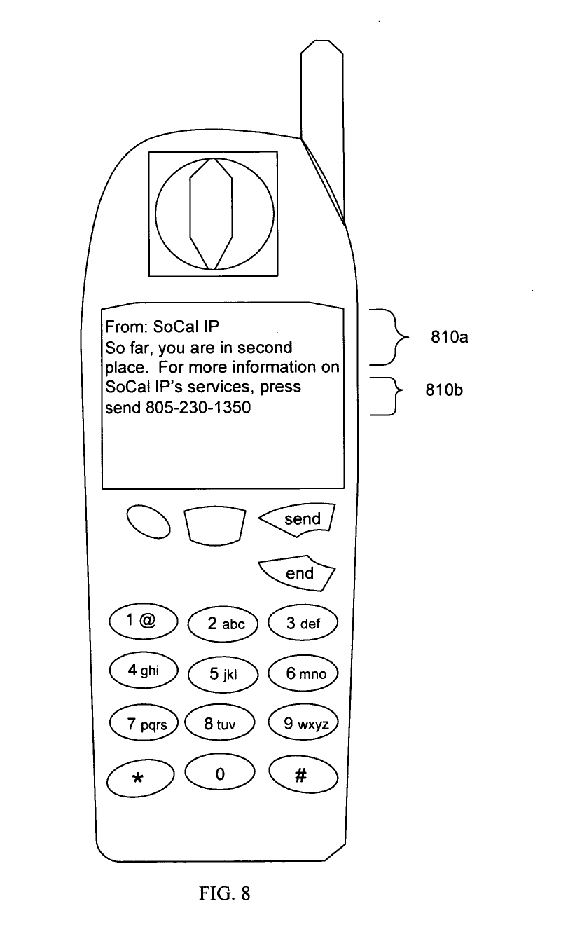

As mentioned, the content program may include a series of content messages. Thus, there may be more messages (step 250) which may be processed as explained above. These messages may be, for example, a quiz question 710a as shown in FIG. 7, or a contest update 810a shown in FIG. 8, or other acknowledgements of their responses to the interest content. The users may also be asked questions relating to their interest in the sponsor's product(s) or service(s). In FIG. 7 and FIG. 8, there is also solicitation content 710b, 810b respectively, which includes a solicitation and a solicitor phone number. As can be seen, the solicitations can be of varying form and substance. By making the content programs compelling, the users may become active participants in the content program and creating stronger ties to the basis for the invitation (e.g., the television, radio, Internet, live stadium/theater/auditorium event).

Although not shown, there may be capabilities for canceling enrollment in a content program, and for designating another or different communications device for receiving the content program.

Referring now to FIG. 3 is shown a flow chart of a method of sending interactive opt-in messages. The flow chart has both a start 305 and an end 395, but the process is cyclical in nature.

In an initial step 310, audience members are invited to enroll in a content delivery service.

Next, plural audience members are enrolled in the content delivery service (step 315). In this step, the users identify the address of a communications device for receipt of the messages. For example, and referring again to FIG. 4, a person may use their mobile phone 110 to send a speed code 410 to a designated phone number via SMS, such as that of the SMS system (FIG. 1). The phone network may then direct the SMS message to the SMS system 130.

Referring again to FIG. 1, the SMS system 130 may recognize an incoming enrollment message from the mobile phone 110 as an enrollment request. The SMS system 130 may then relay this information to the control system 140. The control system 140 may have a database (not shown) for tracking enrollments. When SMS messages are delivered, the phone number of the sender is also usually provided to the recipient. Accordingly, the control system 140 may receive users' content delivery addresses (e.g., the phone number of the users' mobile phones).

Next, messages of the content program are sent to the users' communications devices (step 320) until the content program has ended (step 350).

As explained above, some users may respond to the solicitation content. The system 100 may capture or obtain information about user responses to the solicitation content.

The database of the control system 140 may include numerous fields, including the address designated by enrollees for receiving the content programs, an identification of the content programs which the enrollee has selected to receive, which messages of a given content program have been sent and received by the enrollees, any interactive responses by the enrollees (such as answers to quiz questions), the date and time of enrollee responses, enrollee response times, current standings in competitive games, and game performance. The database may also track how users respond to various solicitation content. The database may further include demographic, psychographic and geographic information about users so that the various information may be correlated and used advantageously.

At least some of the messages in a content program may be customized on the basis of information about an individual user or groups of like users, or other basis. Customization may be to the interest content and/or the solicitation content.

The control system 140 may coordinate content programs with broadcast programs or other content or programs. This coordination may include transmitting a message of a content program to allow audience members to answer questions raised in the broadcast or event. Thus, the control system 140 and TV broadcast system 150 may generate signals and/or messages to one another so that messages of the content programs are synchronized to corresponding broadcast programs. The control system 140 may be programmed to take into account syndication and re-runs of broadcast programs, such that content programs are modified based upon which run of a broadcast program is being aired.

Closing Comments

The foregoing is merely illustrative and not limiting, having been presented by way of example only. Although exemplary embodiments of the invention have been shown and described, it will be apparent to those having ordinary skill in the art that changes, modifications, and/or alterations may be made, none of which depart from the spirit of the present invention. All such changes, modifications and alterations should therefore be seen as within the scope of the present invention.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For any means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A method of interactive opt-in messaging for receiving content on a communications device, the method comprising:
a user requesting enrollment using IVR in a content delivery service for receiving messages in one or more areas of user interest on the communications device receiving a series of messages in the communications device having related user-perceivable content, at least some of the messages comprising
interest content comprising user-perceivable content corresponding to the one or more areas of interest
solicitation content comprising a user-perceivable solicitation and a solicitor phone number
the user responding to one of the solicitations from the communications device by initiating a phone call to the solicitor phone number from the solicitation without the user separately keying in the solicitor phone number.

2. The method of interactive opt-in messaging for receiving content on a communications device of claim 1 further comprising
the user receiving an acknowledgement
the user responding to the request with a confirmation of enrollment.

3. The method of interactive opt-in messaging for receiving content on a communications device of claim 1 wherein the solicitation content of at least one message includes a prompt to which the user can respond directly from the communications device.

4. The method of interactive opt-in messaging for receiving content on a communications device of claim 1 wherein all messages include the interest content and the solicitation content.

5. The method of interactive opt-in messaging for receiving content on a mobile communications device of claim 1 wherein the user-perceivable solicitation content is distinct from the interest content.

6. The method of interactive opt-in messaging for receiving content on a communications device of claim 1 wherein enrolling includes providing a phone number of the communications device.

7. The method of interactive opt-in messaging for receiving content on a communications device of claim 1 wherein the plurality of messages have interest content which altogether form a serial program selected from the group comprising a quiz, a contest, a poll, a survey and a story.

8. The method of interactive opt-in messaging for receiving content on a communications device of claim 1 wherein the communications device is selected from the group comprising a cellular phone, a wireless VoIP phone, a desktop computer and a PDA.

9. A method of interactive opt-in messaging for delivering content, the method comprising:
inviting audience members of a broadcast program to enroll in a content delivery service for receiving a content program relating to an area of interest
enrolling plural audience members in the content delivery service using interactive voice response, including receiving respective addresses of communications devices for the audience members
operating the content program comprising
sending a series of messages having related user-perceivable content to the users' communications devices, at least some of the messages comprising
interest content comprising user-perceivable content relating to the area of interest
solicitation content comprising
a user-perceivable solicitation unrelated to the area of interest
an electronic address for contacting a solicitor with respect to the solicitation.

10. The method of interactive opt-in messaging for delivering content of claim 9 further comprising
sending enrollment acknowledgements to the audience members
receiving a confirmation of enrollment from the audience members.

11. The method of interactive opt-in messaging for delivering content of claim 9 wherein the interest content of at least one message includes a prompt to which the users can respond directly from their communications devices.

12. The method of interactive opt-in messaging for delivering content of claim 9 wherein at least some of the messages are customized based upon information about the enrolled audience members.

13. The method of interactive opt-in messaging for delivering content of claim 9 wherein all messages include interest content and solicitation content.

14. The method of interactive opt-in messaging for delivering content of claim 9 wherein the user-perceivable solicitation content is distinct from the interest content.

15. The method of interactive opt-in messaging for delivering content of claim 9 wherein the addresses of communications devices for the audience members comprise phone numbers.

16. The method of interactive opt-in messaging for delivering content of claim 9 wherein the plurality of messages have interest content which altogether form a serial program selected from the group comprising a quiz, a contest, a poll and a story.

17. An interactive opt-in messaging system for delivering content, the system comprising:
at least one processor
at least one memory
wherein the processor and the memory comprise circuits and software for
inviting audience members of a broadcast program to enroll in a content delivery service for receiving a content program relating to an area of interest
enrolling plural audience members in the content delivery service using interactive voice response, including receiving respective addresses of communications devices for the audience members
operating the content program comprising
sending a series of related messages to the users' communications devices, at least some of the messages comprising
interest content comprising user-perceivable content relating to the area of interest
solicitation content comprising
a user-perceivable solicitation unrelated to the area of interest
an electronic address for contacting a solicitor with respect to the solicitation.

18. The interactive opt-in messaging system for delivering content of claim 17 further comprising circuits and software for
sending enrollment acknowledgements to the audience members
receiving a confirmation of enrollment from the audience members.

19. The interactive opt-in messaging system for delivering content of claim 17 wherein the interest content of at least one message includes a prompt to which the users can respond directly from their communications devices.

20. The interactive opt-in messaging system for delivering content of claim 17 further comprising circuits and software for customizing at least some of the messages based upon information about the enrolled audience members.

21. The interactive opt-in messaging system for delivering content of claim 17 wherein all messages include interest content and solicitation content.

22. The interactive opt-in messaging system for delivering content of claim 17 wherein the user-perceivable solicitation content is distinct from the interest content.

23. The interactive opt-in messaging system for delivering content of claim 17 wherein the addresses of communications devices for the audience members comprise phone numbers.

24. The interactive opt-in messaging system for delivering content of claim 17 wherein the plurality of messages have interest content which altogether form a serial program selected from the group comprising a quiz, a contest, a poll and a story.

25. A communications device for receiving content, the communications device comprising:
a processor
a memory coupled with the processor
a storage medium having instructions stored thereon which when executed cause the communications device to perform actions comprising
requesting enrollment using IVR of the communications device in a content delivery service for receiving messages in one or more areas of user interest
receiving a series of related messages, at least some of the messages comprising
interest content comprising user-perceivable content corresponding to the one or more areas of interest solicitation content comprising a user-perceivable solicitation and a solicitor phone number
permitting the user to respond to the solicitations by initiating a phone call to the solicitor phone number from the solicitation without the user separately keying in the solicitor phone number.

26. The communications device for receiving content of claim 25, wherein the communications device is to perform actions further comprising
receiving an acknowledgement
responding to the request with a confirmation of enrollment.

27. The communications device for receiving content of claim 25 wherein requesting enrollment includes providing a phone number of the communications device.

28. The communications device for receiving content of claim 25 wherein the communications device is selected from the group comprising a cellular phone, a wireless VoIP phone, a desktop computer and a PDA.
